(19) United States
(12) Patent Application Publication
(10) Pub. No.: US 2014/0206216 A1
(43) Pub. Date: Jul. 24, 2014

(54) SUBMINIATURE COAXIAL MICRO SWITCH CONNECTOR

(71) Applicant: INSERT ENTERPRISE CO., LTD., New Taipei City (TW)

(72) Inventors: TUNG-LIANG HUANG, New Taipei City (TW); SUNG-WEN CHEN, New Taipei City (TW)

(73) Assignee: INSERT ENTERPRISE CO., LTD., New Taipei City (TW)

(21) Appl. No.: 13/832,795

(22) Filed: Mar. 15, 2013

(30) Foreign Application Priority Data
Jan. 21, 2013 (TW) 102201261

(51) Int. Cl. H01R 24/46

(52) U.S. Cl. CPC H01R 24/46
USPC 439/188

(57) ABSTRACT

A subminiature coaxial micro switch connector includes a metal casing, an upper insulating cover, a resilient terminal, an immovable terminal and a lower insulating cover; the upper insulating cover, resilient terminal, and immovable terminal thereof are provided without bent thicknesses; the resilient terminal and the immovable terminal are plate-shaped structures to effectively decrease the thicknesses thereof such that the volume of the coaxial micro switch connector is reduced greatly to ease fabrication job and promote efficiency of the production.

### CROSS-REFERENCE TO RELATED APPLICATIONS

The application claims priority from Taiwan Utility Model Application No. 102201261 filed on Jan. 21, 2013, the disclosure of which is incorporated herein by reference.

### BACKGROUND OF THE INVENTION

1. Field of the Invention

The present invention relates to a connector, and, more particularly, to a coaxial micro switch connector for SmartPhone.

2. Description of Related Art

Taiwan Patent No. 582648, which is granted to the present applicant, discloses a subminiature micro switch connector which includes an external terminal, an upper insulating case, a movable terminal, a fixed terminal, and a lower insulating case: the lower insulating case has a receiving groove at the upper end thereof to accommodate the bottom of the upper insulating case, a groove disposed at two opposite sides thereof respectively; both the engaging plates at the movable terminal and the fixed terminal are attached to the respective groove; the external terminal has two bent plates to be attached to the lower end of the lower insulating case; there is a clearance formed at the middles parts of the upper and lower insulating cases to receive the contact plate of the fixing terminal, the contact plate of the movable terminal and the two spring plates; the front end of the contact plate of the movable terminal touches the bottom of the contact plate of the fixed terminal.

Referring to FIGS. 1 and 2, Taiwan Utility Model No. M380636, which is granted to the present applicant for improving the preceding Taiwan Patent No. 582648, disclose a coaxial micro switch connector 1 which includes a metal casing 11, an upper insulating cover 12, a resilient terminal 13. an immovable terminal 14 and a lower insulating cover 15, wherein the resilient terminal 13 has a first fixing plate 131 and a first contact plate 132, two opposite lateral sides of the first contact plate 132 respectively extend a spring plate 133 which has an outward bent section 134 at the lowest end thereof to horizontally contact the upper side 151 of the lower insulating cover 15 instead of penetrating the lower insulating cover 15; two locking ears 121 of the upper insulating cover 12 engage with the two engaging recesses 152 of the lower insulating cover 15 to allow the upper insulating cover 12, the resilient terminal 13, the immovable terminal 14 and the lower insulating cover 15 joining together steadily; during the process of assembling the metal casing 11, it is incapable of occurring the problem relating the parts separating from each other so as to ease the fabricating job; therefore, labors and work hours are decreased, the defect rate is lowered, and the production cost is economical.

The coaxial micro switch connector made in accordance with Taiwan Utility Model No. M380636 provides a length of 3 mm, a width of 3 mm and a height of 1.75 mm. However, the requirements for SmartPhone arc much less in lightness and thinness, and the preceding coaxial micro switch connector has been incapable of applying to the much lighter and thinner SmartPhone.

### SUMMARY OF THE INVENTION

The main objective of the present invention is to provide a subminiature coaxial micro switch connector which has a structure with much less thinness capable of applying to the much lighter and thinner SmartPhone.

Another object of the present invention is to provide a subminiature coaxial micro switch connector which provides much simple structure for easing fabrication and enhancing production efficiency.

### BRIEF DESCRIPTION OF THE DRAWINGS

Further benefits and advantages of the present invention will become apparent after a careful reading of the detailed description with appropriate reference to the accompanying drawings.

FIG. 1 is an exploded perspective view of the conventional coaxial micro switch connector;

FIG. 2 is a perspective view of the conventional coaxial micro switch connector shown in FIG. 1;

FIG. 3 is an exploded perspective view of a subminiature coaxial micro switch connector according to the present invention;

FIG. 4 is a perspective view of the subminiature coaxial micro switch connector according to the present invention of FIG. 3;

FIG. 5 is a sectional view along line A-A of the subminiature coaxial micro switch connector shown in FIG. 4;

FIG. 6 is a sectional view along line B-B of the subminiature coaxial micro switch connector shown in FIG. 4;

FIG. 7 is a sectional view illustrating another connector in association with the subminiature coaxial micro switch connector according to the present invention;

FIG. 8 is a sectional view illustrating another connector in association with the subminiature coaxial micro switch connector according to the present invention.

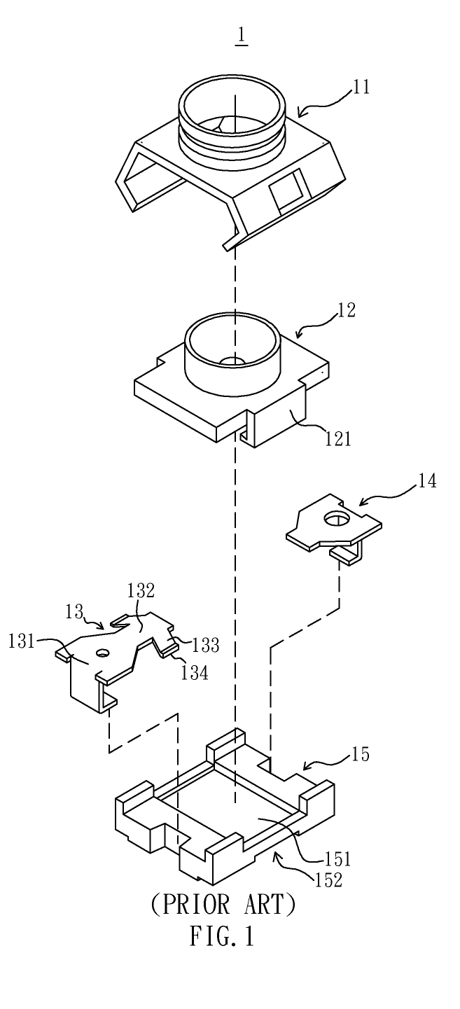

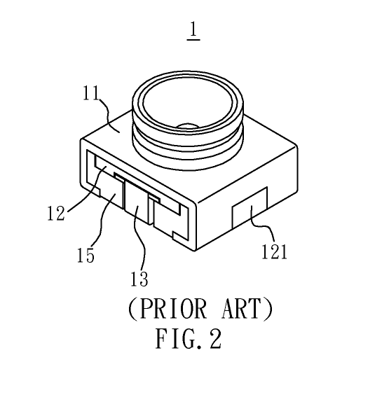

### DETAILED DESCRIPTION OF THE INVENTION

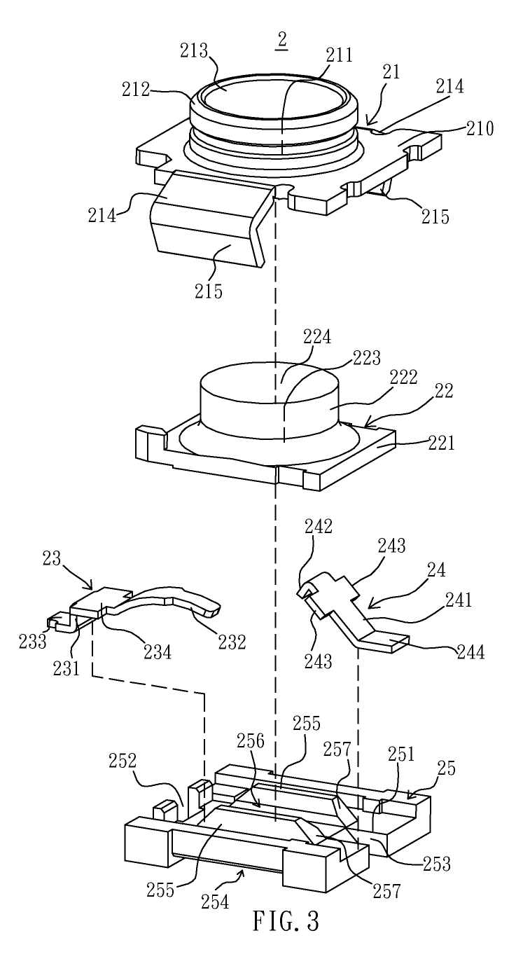

Referring to FIG. 3, the subminiature coaxial micro switch connector 2 according to the present invention comprises a metal casing 21, an upper insulating cover 22, a resilient terminal 23, an immovable terminal 24, and a lower insulating cover 25. The resilient terminal 23 and the immovable terminal 24 are made of metal in addition to the metal casing 21. The upper insulating cover 22 and the lower insulating cover 25 are made of insulation material such as plastics or resins. The shape of the metal casing 21 shown in FIG. 3 is before assembling with other parts.

The metal casing 21 has a first plate member 210 with a first hole 211 at the center thereof. A first cylindrical member 212 extends upward from the first hole 211 with a first opening 213 communicating with the first hole 211. Two opposite sides of the first plate member 210 extend downward a first bent plate part 214 and a second bent plate part 215 respectively with the second bent plate part 215 further extending toward the inner side of the first bent plate part 214.

A second plate member 221 and a second cylindrical member 222 are integrated with the upper insulating cover 22. A second hole 223 is disposed at the center of the second plate member 221. The second cylindrical member 222 extends upward from the circumferential side of the second hole 223 with a trumpet-shaped second opening 224 disposed at the inner side of the second cylindrical member 222 and communicating with the second hole 223.

The resilient terminal 23 is plate-shaped with a first fixing plate part 231 and a first contact plate part 232. The first fixing plate part 231 is step-shaped and has a lower plate section 233 and an upper plate section 234; the lower plate section 233 is used for being soldered with a circuit board, and the upper plate section 234 connects with the first contact plate part 232. The first contact plate part 232 extends upward a concave downward shape from the upper plate section 234.

The immovable terminal 24 is plate-shaped with a second fixing plate part 241 and a second contact plate part 242 integrated with each other. The second contact plate part 242 extends toward the second fixing plate part 242 about 90′ from the upper end of the second fixing plate part 241; there is a respective wing plate part 243 extends outward from two opposite sides of the upper end of the second fixing plate part 241. A second lower plate section 244 is disposed at the lower end of the second fixing plate part 241. The lower plate section 244 is used for being soldered with the circuit board as well.

There is a receiving groove 251 disposed on the lower insulating cover 25. Two opposite lateral sides of the lower insulating cover 25 are disposed with a first recess section 252 and a second recess section 253 corresponding to the first fixing plate part 231 of the resilient terminal 23 and the second fixing plate part 241 of the immovable terminal 24 respectively. An engaging groove 254 is disposed at another two opposite lateral sides and the bottom of the lower insulating cover 25 corresponding to the first bent plate part 214 and the second bent plate part 215 of the metal casing 21. There are two parallel protruding plate parts 255 on the lower insulating cover 25 to form a furrow 256 in between. The protruding plate parts 255 are situated in the receiving groove 251.

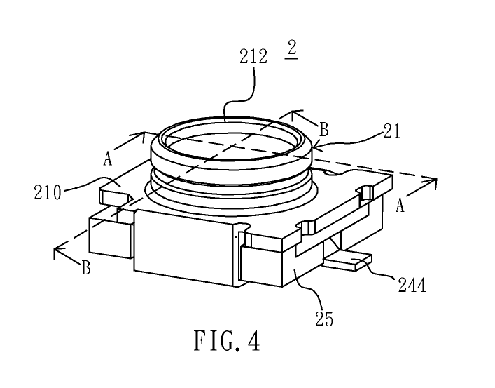

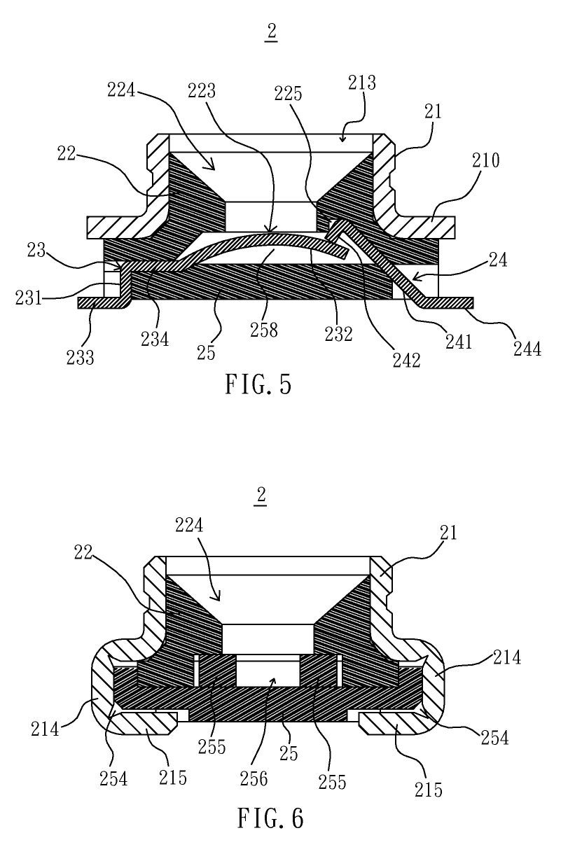

Referring to FIGS. 4 to 6 in company with FIG. 3 again, when the subminiature coaxial micro switch connector 2 is set up. first of all, the second fixing plate part 241 of the immovable terminal 24 is placed in the second recess section 253 of the lower insulating cover 25; the second lower plate section 244 at the lower end of the second fixing plate part 241 is placed under the lower insulating cover 25 as shown in FIG. 5; the two wing plate parts 243 abut against tilting sides 257 of the protruding plate parts 255.

Then, the first fixing plate part 231 of the resilient terminal 23 is placed in the first recess section 252 of the lower insulating cover 25; the lower plate section 233 of the first fixing plate part 231 is placed under the lower insulating cover 25; the first contact plate part 232 is placed in the furrow 256 between the two protruding plate parts 255; the upper side of the first contact plate part 232 contacts with the lower side of the second contact plate part 242 as shown in FIG. 5.

Further, the upper insulating cover 22 is stacked on the lower insulating cover 25 to admit the upper end of the second fixing plate part 241 being disposed in a locating recess 225 in the upper insulating cover 22, and the upper plate section 234 of the first fixing plate part 231 and the second fixing plate part 241 are retained between the upper insulating cover 22 and the lower insulating cover 25 as shown in FIGS. 3, 5 and 6.

Further, the second cylindrical member 222 at the upper insulating cover 22 is placed in the first cylindrical member 212 at the metal casing 21, and the upper and lower insulating covers 22, 25 are disposed between the two first bent plate part 214 and the two second bent plate parts 215; finally, the first bent plate parts 214 and the second bent plate parts are engage with the two engaging grooves 254 so as to assemble the metal casing 21, the upper insulating cover 22, the resilient terminal 23, the immovable terminal 24 and the lower insulating cover 25 together as a single unit.

Referring FIGS. 3 and 5 again, the upper insulating cover 22 and the receiving groove 251 of the lower insulating cover 25 define a clearance to receive the first contact plate part 232 and the second contact plate part 242; the first contact plate part 232 contacts with the tail end of the second contact plate part 242.

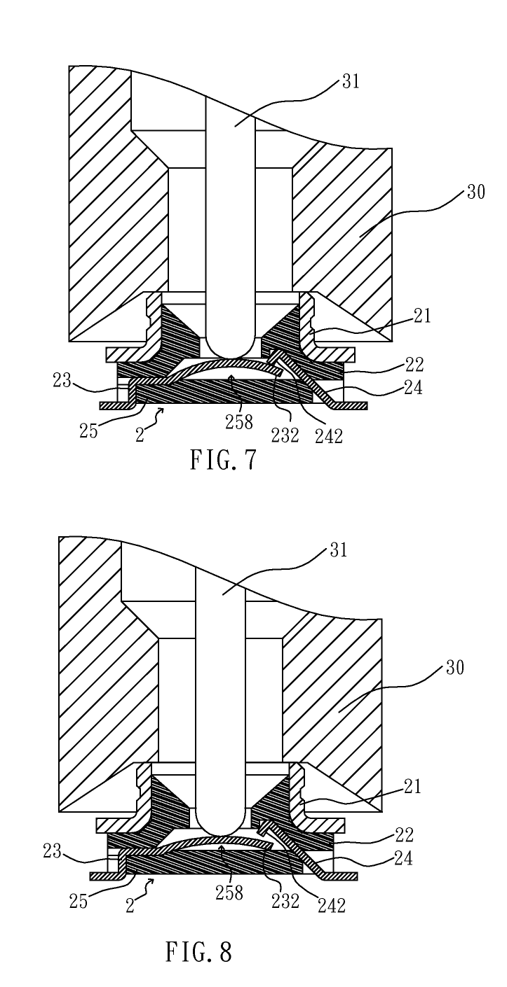

Referring to FIGS. 7 and 8, when a terminal 31 of another connector 30 moves downward, the terminal 31 pushes the first contact plate part 232 which is elastically deformed in a state of being detached from the second contact plate part 242 as shown in FIG. 8. When the terminal 31 is pulled back, an elastic restoring force of the first contact plate part 232 generated from being deformed allows the first contact plate part 232 to move back and contact with the second contact plate part 242 again as shown in FIG. 7.

In practice, the subminiature coaxial micro switch connector according to the present invention has a length of 2 mm, a width of 2 mm, and a height of 0.85 mm such that the volume and the thickness thereof are much less than the prior art coaxial micro switch connector; comparing to the prior art coaxial micro switch connector, the volume and thickness of the subminiature coaxial micro switch connector according to the present invention are 22% and 49% of the prior art coaxial micro switch connector. Thus, the subminiature coaxial micro switch connector according to the present invention can satisfy the SmartPhone with requirements of much less lightness and thinness.

It is appreciated that the subminiature coaxial micro switch connector according to the present invention provides the upper insulating cover, resilient terminal, and immovable terminal thereof without bent thicknesses to improve the structure disclosed in Taiwan Utility Model No. M380636. In addition, the resilient terminal and the immovable terminal are plate-shaped structures such that it is capable of effectively decreasing the thicknesses thereof to reduce the volume of the coaxial micro switch connector greatly; therefore, it is convenient for fabricating the connector so as to promote the production efficiency.

Although the invention has been explained in relation to its preferred embodiment, it is to be understood that many other possible modifications and variations can be made without departing from the spirit and scope of the invention as hereinafter claimed.

What is claimed is:

1. A subminiature coaxial micro switch connector comprising:
a metal casing further comprising a first plate member with a first hole at the center thereof, a first cylindrical member with a first opening extending upward from the first hole and communicating with the first hole, a first bent plate part and a second bent part joining with each other and extending downward from two opposite sides of the first plate member respectively with the second bent plate part further extending toward the inner side of the first bent plate part;
an upper insulating cover further comprising a second plate member and a second cylindrical member integrated with the second plate member, wherein a second hole is disposed at the center of the second plate member, the second cylindrical member extends upward from the circumferential side of the second hole, and a trumpet-shaped second opening is disposed at the inner side of the second cylindrical member to communicate with the second hole;
a plate-shaped resilient terminal further comprising a first fixing plate part and a first contact plate part which are integrated with each other, wherein the first fixing plate part is step-shaped and has a flat shaped first lower plate section and an upper plate section which connects with the first contact plate part which further extends upward a concave downward shape from the upper plate section;
a plate-shaped immovable terminal further comprising a second fixing plate part and a second contact plate part integrated with each other wherein the second contact plate part extends toward the second fixing plate part from the upper end of the second fixing plate part;
a lower insulating cover with a top, two pairs of lateral sides and a bottom further comprising a receiving groove disposed at the top, a first and second recess sections disposed at one of two pair of lateral sides corresponding to the first fixing plate part of the resilient terminal and the second fixing plate part of the immovable terminal respectively, two engaging groove disposed at another pair of lateral sides and the bottom corresponding to the first and second bent plate parts respectively, and two parallel protruding plate parts forming a furrow in between and being situated in the receiving groove;
wherein the first fixing plate part is placed in the first recess section; the second fixing plate part is placed in the second recess section of the lower insulating cover; the first contact plate part is placed in the furrow between the two protruding plate parts; the upper side of the first contact plate part contacts with the lower side of the second contact plate part; the upper insulating cover is stacked on the lower insulating cover; the upper plate section of the first fixing plate part and the second fixing plate part are retained between the upper insulating cover and the lower insulating cover; the second cylindrical member is placed in the first cylindrical member; the two first bent plate parts and the two second bent plate parts are engaged with the two engaging grooves of the lower insulating cover; the upper insulating cover and the receiving grooves define a clearance to receive the first contact plate part and the second contact plate part.

2. The subminiature coaxial micro switch connector as defined in claim 1 wherein the first lower plate section is placed under the lower insulating cover.

3. The subminiature coaxial micro switch connector as defined in claim 2, wherein a second lower plate section is disposed at the second fixing plate part and placed under the lower insulating cover.

4. The subminiature coaxial micro switch connector as defined in claim 1, wherein a locating recess is disposed in the upper insulating cover, and the upper end of the second fixing plate part placed in the locating recess.

5. The subminiature coaxial micro switch connector as defined in claim 2, wherein a locating recess is disposed in the upper insulating cover, and the upper end of the second fixing plate part placed in the locating recess.

6. The subminiature coaxial micro switch connector as defined in claim 3, wherein a locating recess is disposed in the upper insulating cover, and the upper end of the second fixing plate part placed in the locating recess.

7. The subminiature coaxial micro switch connector as defined in claim 1, wherein the upper end of the second fixing plate part has two wing plate parts extending from two opposite sides of the second fixing plate part respectively; the two protruding plate parts have tilting sides and the two wing plate parts abut against the tilting sides of the protruding plate parts.

8. The subminiature coaxial micro switch connector as defined in claim 7, wherein a locating recess is disposed in the upper insulating cover, and the upper end of the second fixing plate part placed in the locating recess.

9. The subminiature coaxial micro switch connector as defined in claim 2, wherein the upper end of the second fixing plate part has two wing plate parts extending from two opposite sides of the second fixing plate part respectively; the two protruding plate parts have tilting sides and the two wing plate parts abut against the tilting sides of the protruding plate parts.

10. The subminiature coaxial micro switch connector as defined in claim 9, wherein a locating recess is disposed in the upper insulating cover, and the upper end of the second fixing plate part placed in the locating recess.

11. The subminiature coaxial micro switch connector as defined in claim 3, wherein the upper end of the second fixing plate part has two wing plate parts extending from two opposite sides of the second fixing plate part respectively; the two protruding plate parts have tilting sides and the two wing plate parts abut against the tilting sides of the protruding plate parts.

12. The subminiature coaxial micro switch connector as defined in claim 11, wherein a locating recess is disposed in the upper insulating cover, and the upper end of the second fixing plate part placed in the locating recess.
